(19) United States
(12) Patent Application Publication
(10) Pub. No.: US 2025/0255229 A1
(43) Pub. Date: Aug. 14, 2025

(54) Grapple Arrangement To Collect Tree Waste Debris And Similar Debris

(71) Applicant: Brian Burge, Marion, SD (US)

(72) Inventor: Brian Burge, Marion, SD (US)

(21) Appl. No.: 18/441,093

(22) Filed: Feb. 14, 2024

(51) Int. Cl. A01G 23/00

(52) U.S. Cl. CPC A01G 23/003

(57) ABSTRACT

A grapple arrangement to collect tree waste debris and similar debris includes a bottom jaw, a top jaw, and a drive arrangement. Each of the top jaw and the bottom jaw is designed to grasp and collect tree waste debris and similar debris of all sizes to minimize manual collection of branches, twigs, and other smaller tree waste debris and similar debris with minimal impact or damage to the surrounding ground, grass, and other environmental objects or structures.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to grapples for collecting tree waste and more particularly pertains to a new grapple arrangement to collect tree waste debris and similar debris. Grapples are used primarily to pick up large pieces of trees, such as trunks and branches.

Another use of grapples is for clearing and collecting tree waste debris and other unwanted environmental debris, such as roots, stumps, bushes, rocks, and branches. In most cases, these grapples have a bottom jaw that functions like a scoop or shovel to get under debris and dig debris out of the ground, and a top jaw that interacts with the bottom jaw to grasp debris. In operation, such grapples not only dig up and/or collect the debris, but they also dig or tear up the surrounding ground, grass, and other non-debris. In farming or construction where it is desirable to clear the land completely, such destruction of the ground is acceptable if not desirable. However, there are situations where such destruction is undesirable, such as in residential tree removal or clean up where it is desirable to collect the tree waste debris without substantially disturbing or damaging the ground and grass. In addition, grapples are designed to grasp and collect larger objects, such as tree trunks, logs, large branches, and rocks. Smaller objects such as small branches or twigs, are not grasped by the grapple jaws or fall through the grapple jaws. This necessitates additional effort and work to collect such smaller tree waste debris, or the user must collect everything in a large clump, including the surrounding ground and grass, which may be undesirable as discussed above.

### (2) Description of Related Art Including Information Disclosed Under 37 CFR 1.97 and 1.98

The prior art relates to grapples for collecting tree waste. The prior art, as best understood, does not disclose a grapple having a top jaw and a bottom jaw that are designed to grasp and collect tree waste debris of all sizes to minimize manual collection of branches, twigs, and other smaller tree waste debris with minimal impact or damage to the surrounding ground, grass, and other environmental objects or structures.

### (h) BRIEF SUMMARY OF THE INVENTION

An embodiment of the disclosure meets the needs presented above in a grapple arrangement to collect tree waste debris generally comprising a bottom jaw, a top jaw, and a drive arrangement. The bottom jaw is designed to be mounted on a support arm structure of a wheeled or tracked base machine. The bottom jaw is in the form of a scoop to temporarily hold collected tree waste debris therein. The bottom jaw includes a bottom jaw front edge portion. The top jaw is pivotably connected to the bottom jaw to interact with the bottom jaw to grasp tree waste debris. The top jaw includes a top jaw front edge portion. The drive arrangement is operatively connected to the top jaw to pivot the top jaw with respect to the bottom jaw between an open position in which the top jaw front edge portion is spaced a distance from the bottom jaw front edge portion and a closed position in which the top jaw front edge portion is positioned adjacent or engaged with the bottom jaw front edge portion. Each of the top jaw and the bottom jaw is designed to grasp and collect tree waste debris of all sizes to minimize manual collection of branches, twigs, and other smaller tree waste debris with minimal impact or damage to the surrounding ground, grass, and other environmental objects or structures.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a grapple arrangement to collect tree waste debris according to an embodiment of the disclosure installed on a wheeled vehicle.

FIG. 2 is a front perspective view of an embodiment of the disclosure shown in FIG. 1.

FIG. 3 is a bottom perspective view of the grapple arrangement according to an embodiment of the disclosure.

FIG. 4 is a top view of an embodiment of the disclosure.

FIG. 5 is a bottom view of an embodiment of the disclosure.

FIG. 6 is a front view of an embodiment of the disclosure.

FIG. 7 is a front view of an embodiment of the disclosure.

FIG. 8 is a side view of an embodiment of the disclosure.

FIG. 9 is a side view of an embodiment of the disclosure.

FIG. 10 is a front view of an embodiment of the disclosure in use.

FIG. 11 is a front perspective view of an embodiment of the disclosure.

### (j) DETAILED DESCRIPTION OF THE INVENTION

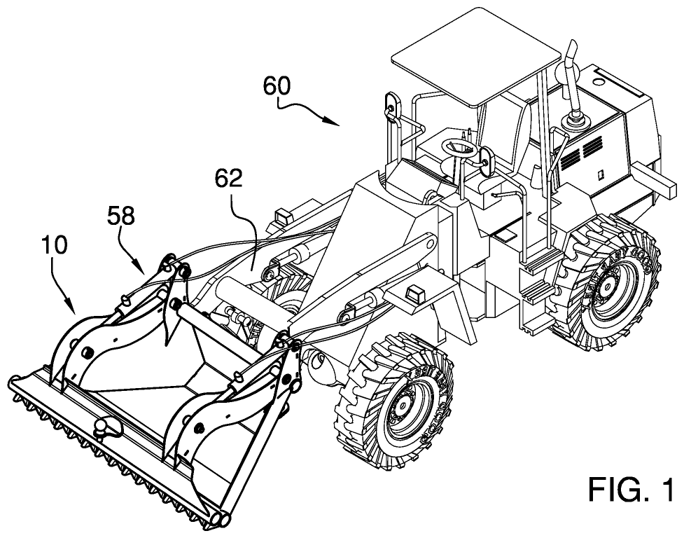

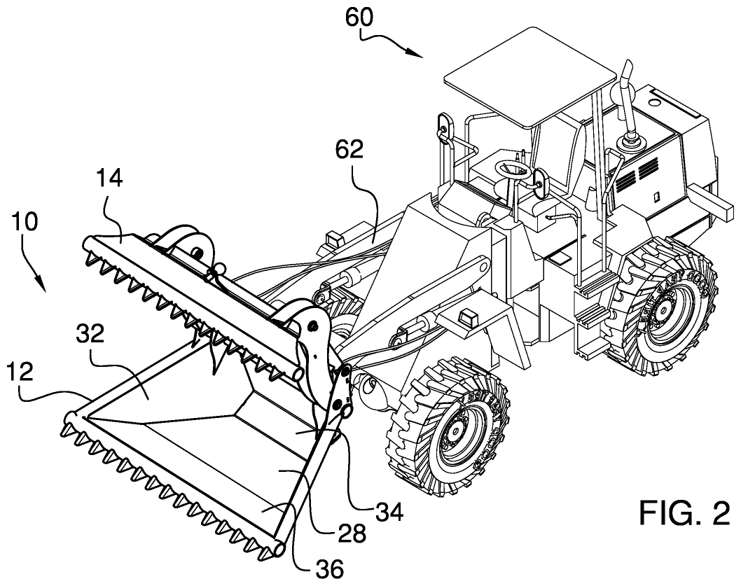

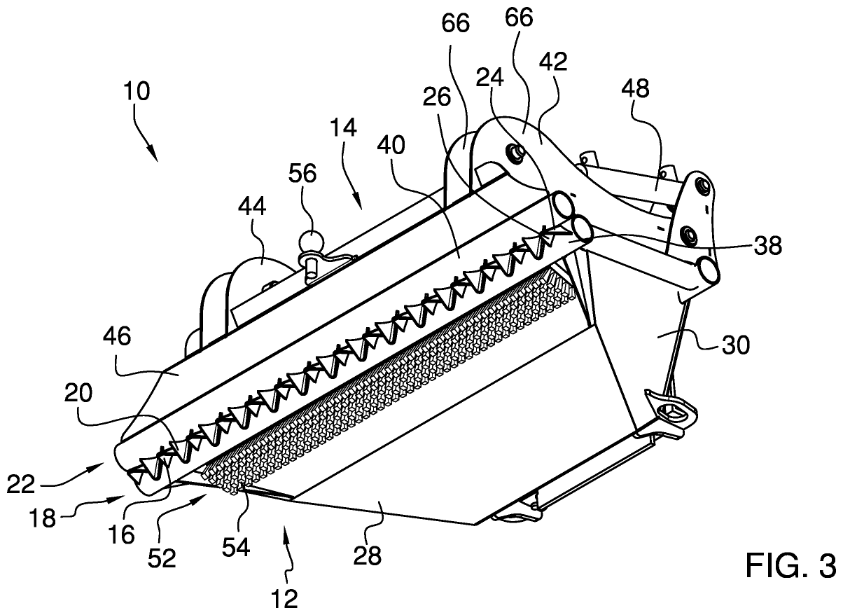

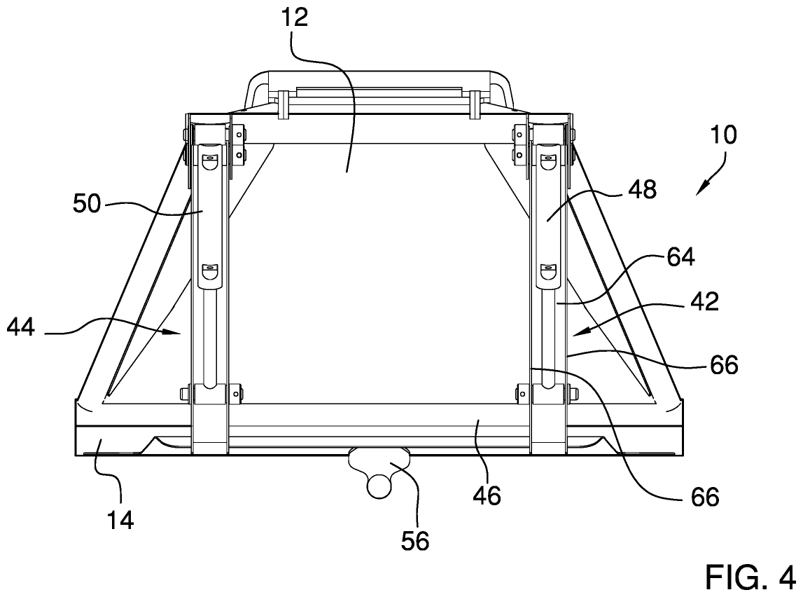

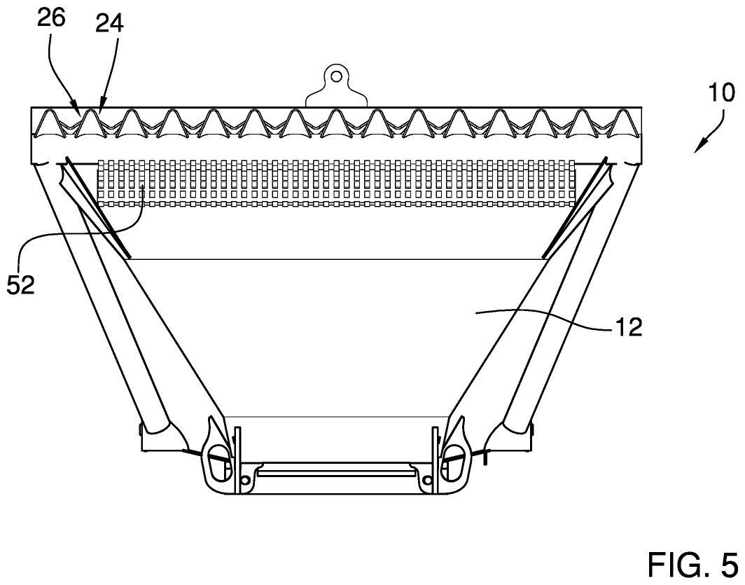

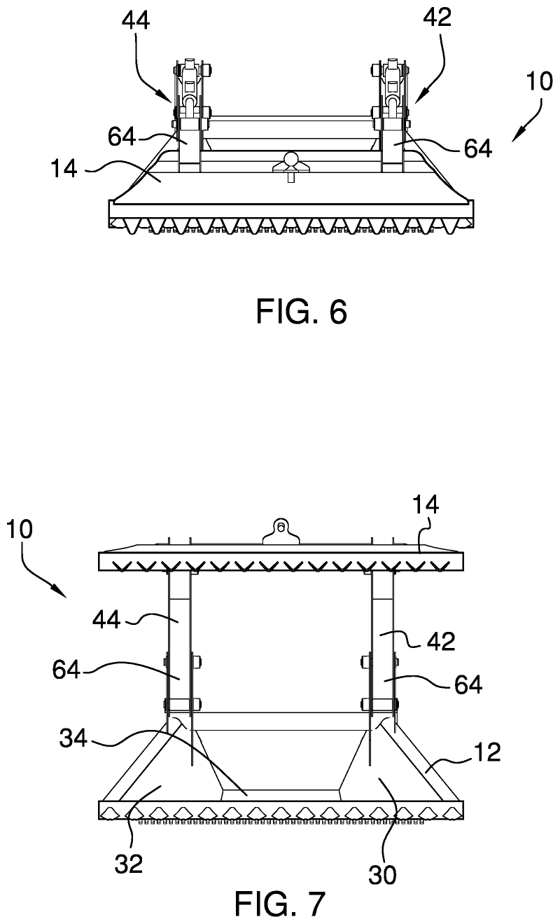

With reference now to the drawings, and in particular to FIGS. 1 through 11 thereof, a new grapple arrangement to collect tree waste debris embodying the principles and concepts of an embodiment of the disclosure and generally designated by the reference numeral 10 will be described.

As best illustrated in FIGS. 1 through 11, the grapple arrangement 10 generally comprises a bottom jaw 12, a top jaw 14, and a drive arrangement 58. The bottom jaw 12 is designed to be mounted on a support arm structure 62 of a wheeled or tracked base machine 60. The bottom jaw 12 is in the form of a scoop to temporarily hold collected tree waste debris therein. The bottom jaw 12 includes a bottom jaw front edge portion 18. The top jaw 14 is pivotably connected to the bottom jaw 12 to interact with the bottom jaw 12 to grasp tree waste debris. The top jaw 14 includes a top jaw front edge portion 22. The drive arrangement 58 is operatively connected to the top jaw 14 to pivot the top jaw 14 with respect to the bottom jaw 12 between an open position in which the top jaw front edge portion 22 is spaced a distance from the bottom jaw front edge portion 18 and a closed position in which the top front edge portion 22 is positioned adjacent or engaged with the bottom jaw front edge portion 18. Each of the top jaw 14 and the bottom jaw 12 is designed to grasp and collect tree waste debris of all sizes to minimize manual collection of branches, twigs, and other smaller tree waste debris with minimal impact or damage to the surrounding ground, grass, and other environmental objects or structures.

In accordance with at least one possible embodiment, the bottom jaw 12 includes bottom teeth 16 disposed at the bottom jaw front edge portion 18. The top jaw 14 includes top teeth 20 disposed at the top jaw front edge portion 22. Each of the bottom teeth 16 includes a first triangular tooth face 24 and a second triangular tooth face 26 connected together along their closed edges at an acute angle to one another. Each of the first triangular tooth face 24 and the second triangular tooth face 26 is positioned to project from the bottom jaw front edge portion 18 such that, upon use of the grapple arrangement 10, their free edges are substantially parallel to the ground and their closed edges are at an acute angle to the ground. This design permits the bottom teeth 16 to comb through grass and separate small branches and twigs embedded in the grass and guide them into the bottom jaw 12 in a scooping manner. Since the free edges are substantially parallel to a ground surface, the bottom teeth 16 will not dig into the ground in any substantive or destructive manner.

In accordance with at least one possible embodiment, the bottom jaw 12 includes a bottom portion 28, a left side portion 30, a right side portion 32, a rear portion 34, and a front portion 36, all connected together to form a pan or trough. The front portion 36 and the bottom portion 28 taper in width from the bottom jaw front edge portion 18 to the rear portion 34 to maximize the entry space for tree waste debris to facilitate collection of tree waste debris and minimize the overall size and weight of the bottom jaw 12 to maximize maneuverability and lifting capacity of the wheeled or tracked base machine 60. Since the bottom jaw 12 is in the form of a scoop, pan, or trough, the weight will be greater than with grapples that have a grid or open or slotted design, so the tapered design helps minimize the weight.

In accordance with at least one possible embodiment, the bottom jaw front edge portion 18 includes a bottom jaw lip 38 that is elongated and has a rounded or circular cross-section. The top jaw front edge portion 22 includes a top jaw lip 40 that is elongated and has a rounded or circular cross-section. The top jaw lip 40 is designed to sealingly engage with the bottom jaw lip 38 to minimize or prevent small tree waste debris from escaping from the bottom jaw 12 between the top teeth 20 and the bottom teeth 16 upon the top jaw 14 and the bottom jaw 12 is in the closed position. Due to the rounded or circular design, the bottom jaw lip 38 will engage along a linear contact point with the top jaw lip 40. With current grapple designs, small branches and twigs can easily fall out between the jaws because there is no sealing engagement at the front end.

In accordance with at least one possible embodiment, the top teeth 20 and the bottom teeth 16 are spaced apart and designed to interlace with one another upon the top jaw 14 and the bottom jaw 12 is in the closed position to capture and hold small tree waste debris not collected into the bottom jaw 12 between adjacent teeth.

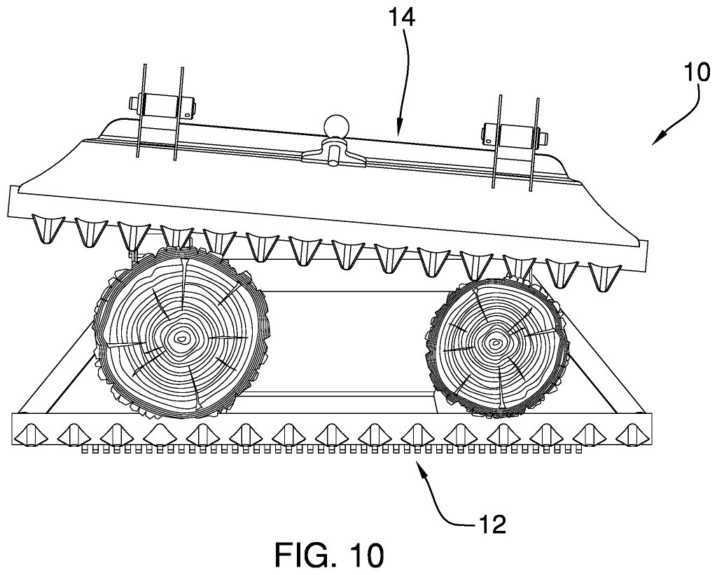

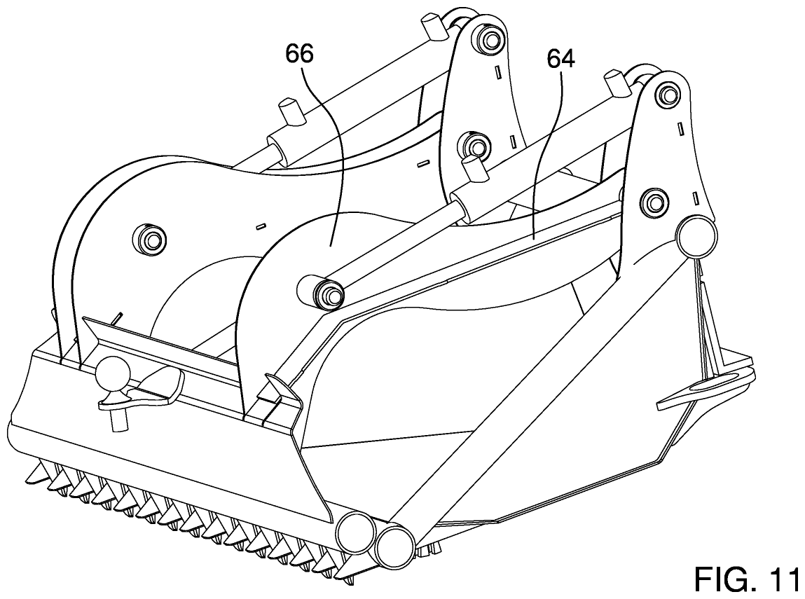

In accordance with at least one possible embodiment, the top jaw 14 includes a left arm arrangement 42, a right arm arrangement 44, and a front plate 46 is elongated and extending transverse to and mounted at the distal ends of the left arm arrangement 42 and the right arm arrangement 44. The top jaw front edge portion 22 is positioned on the front plate 46. The left arm arrangement 42 and the right arm arrangement 44 are spaced apart from one another and connected to opposite ends of the front plate 46. The drive arrangement 58 comprises a left drive device 48 designed to raise and lower the left arm arrangement 42 and a right drive device 50 designed to raise and lower the right arm arrangement 44. The left arm arrangement 42 and the right arm arrangement 44 have an open design to permit torsional twisting or progressively limited rotation of the front plate 46 to permit the top jaw 14 and the bottom jaw 12 to simultaneously grip a larger piece of tree waste debris adjacent the left arm arrangement 42 and a smaller piece of tree waste debris adjacent the right arm arrangement 44 or vice versa, as shown in FIG. 10. In the embodiment shown in FIGS. 1 to 9, each of the left arm arrangement 42 and the right arm arrangement 44 includes a cross plate 64 and two curved or s-shaped plates 66 disposed essentially parallel to one another and connected together by said cross plate 64 to form a substantially H-shaped cross-sectional profile. In current arm arrangements for grapples, similar arms have closed profiles in the shape of a rectangular tube or bar or similar, which would prevent or severely restrict torsional twisting of the jaw connected thereto. The open design of the present invention, that is, two plates 66 connected by the cross plate 64 in an approximate H-shape permits such torsional twisting of the front plate 46 and top jaw 14, which is relatively unrestricted at first to permit grasping of different-sized debris, as shown in FIG. 10, but is progressively limited to prevent excessive twisting or over-rotation. In addition, the increased resistance to twisting also creates a spring back or additional clamping force to create an increased grip on the debris caught between the top jaw 14 and the bottom jaw 12. FIG. 11 shows a cutaway view in which one of the plates 66 has been omitted to clearly show one possible design of the cross plate 64, wherein the cross plate 64 has an angled design suitable for the S-shape of the plates 66, though essentially any design is contemplated by the application that would be suitable for a selected design of the plates 66.

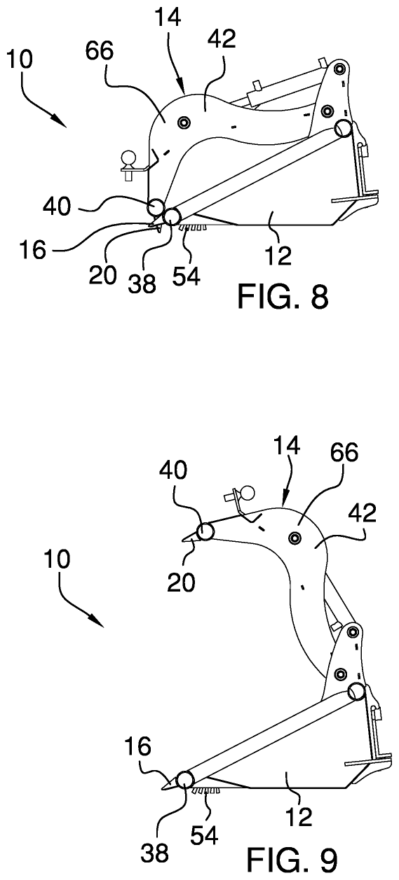

In accordance with at least one possible embodiment, the grapple arrangement 10 further includes a brush head 52. The brush head 52 is mounted in a recessed pocket on the underside of the bottom jaw 12 adjacent and rearward of the bottom jaw front edge portion 18. The brush head 52 includes bristles 54 that are oriented transverse to the ground such that, upon use and forward movement of the grapple arrangement 10, the bristles 54 brush against tree waste debris under the bottom jaw 12 and propel tree waste debris out from under the bottom jaw 12 to facilitate collection thereof. In other words, the brush head 52 functions much like a broom or rake to dislodge and/or propel twigs and branches forward as the bristles 54 deflect slightly off the ground then spring forward like a broom or rake. As best seen in FIGS. 8 and 9, only the distal ends of the bristles 54 project out of the recessed pocket such that upon use and forward movement of the grapple arrangement 10, the bristles 54 brush against tree waste debris and/or the ground with minimal loading and deflection of the bristles 54. Such a recessed design minimizes wear and damage to the bristles 54 and the brush head 52 and promotes more complete and effective brushing of tree waste debris.

In accordance with at least one possible embodiment, the rear portion 34 and the front portion 36 are angled or sloped upwardly away from the bottom portion 28 of the bottom jaw 12 to maximize sliding of the bottom jaw 12 over a ground surface with minimal impact or engagement with the ground surface and thus minimal damage to the ground surface upon use of the grapple arrangement 10.

In accordance with at least one possible embodiment, the grapple arrangement 10 further includes a tow hitch 56 mounted on the top jaw front edge portion 22 to permit a user to tow a towable vehicle or trailer with the grapple arrangement 10.

The grapple arrangement 10 functions much like any other grapple for tree debris, but the different components and designs described above enable the grapple arrangement 10 to collect small tree debris that is missed by standard grapples. The grapple arrangement 10 also does not damage the ground as it will skim along the surface during use. As a result, a user can both collect small tree debris and avoid damaging the surrounding area, which is not believed to be possible with current grapple designs.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A grapple arrangement to collect tree waste debris and similar debris comprising:
a bottom jaw being configured to be mounted on a support arm structure of a wheeled or tracked base machine;
said bottom jaw being in the form of a scoop to temporarily hold collected tree waste debris therein;
said bottom jaw comprising a bottom jaw front edge portion;
a top jaw being pivotably connected to said bottom jaw to interact with said bottom jaw to grasp tree waste debris;
said top jaw comprising a top jaw front edge portion;
a drive arrangement being operatively connected to said top jaw to pivot said top jaw with respect to said bottom jaw between an open position in which said top jaw front edge portion is spaced a distance from said bottom jaw front edge portion and a closed position in which said top jaw front edge portion is disposed adjacent or engaged with said bottom jaw front edge portion; and
each of said top jaw and said bottom jaw being configured to grasp and collect tree waste debris of all sizes to minimize manual collection of branches, twigs, and other smaller tree waste debris with minimal impact or damage to the surrounding ground, grass, and other environmental objects or structures.

2. The grapple arrangement of claim 1, wherein:
said bottom jaw comprising bottom teeth disposed at said bottom jaw front edge portion;
said top jaw comprising top teeth disposed at said top jaw front edge portion;
each of said bottom teeth comprising a first triangular tooth face and a second triangular tooth face connected together along their closed edges at an acute angle to one another; and
each of said first triangular tooth face and said second triangular tooth face being disposed to project from said bottom jaw front edge portion such that upon use of the grapple arrangement their free edges are substantially parallel to the ground and their closed edges are at an acute angle to the ground to permit said bottom teeth to comb through grass and separate small branches and twigs embedded in the grass and guide them into said bottom jaw in a scooping manner.

3. The grapple arrangement of claim 2, wherein:
said bottom jaw comprises a bottom portion, a left side portion, a right side portion, a rear portion, and a front portion, all connected together to form a pan or trough; and
said front portion and said bottom portion taper in width from said bottom jaw front edge portion to said rear portion to maximize the entry space for tree waste debris to facilitate collection of tree waste debris and minimize the overall size and weight of said bottom jaw to maximize maneuverability and lifting capacity of a wheeled or tracked base machine.

4. The grapple arrangement of claim 3, wherein:
said bottom jaw front edge portion comprises a bottom jaw lip being elongated and having a rounded or circular cross-section;
said top jaw front edge portion comprises a top jaw lip being elongated and having a rounded or circular cross-section; and
said top jaw lip is configured to sealingly engage with said bottom jaw lip to minimize or prevent small tree waste debris from escaping from said bottom jaw between said top teeth and said bottom teeth upon said top jaw and said bottom jaw being in said closed position.

5. The grapple arrangement of claim 4, wherein said top teeth and said bottom teeth are spaced apart and configured to interlace with one another upon said top jaw and said bottom jaw being in said closed position to capture and hold small tree waste debris not collected into said bottom jaw between adjacent teeth.

6. The grapple arrangement of claim 5, wherein:
said top jaw comprises a left arm arrangement, a right arm arrangement, and a front plate being elongated and extending transverse to and mounted at the distal ends of said left arm arrangement and said right arm arrangement;
said top jaw front edge portion is disposed on said front plate;
said left arm arrangement and said right arm arrangement are spaced apart from one another and connected to opposite ends of said front plate;
said drive arrangement comprises a left drive device configured to raise and lower said left arm arrangement and a right drive device configured to raise and lower said right arm arrangement; and
said left arm arrangement and said right arm arrangement have an open design to permit torsional twisting or progressively limited rotation of said front plate to permit said top jaw and said bottom jaw to simultaneously grip a larger piece of tree waste debris adjacent said left arm arrangement and a smaller piece of tree waste debris adjacent said right arm arrangement or vice versa.

7. The grapple arrangement of claim 6, wherein each of said left arm arrangement and said right arm arrangement comprises a cross plate and two curved or s-shaped plates disposed essentially parallel to one another and connected together by said cross plate to form a substantially H-shaped cross-sectional profile.

8. The grapple arrangement of claim 7, wherein:
the grapple arrangement further comprises a brush head;
said brush head is mounted in a recessed pocket on the underside of said bottom jaw adjacent and rearward of said bottom jaw front edge portion; and
said brush head comprises bristles oriented transverse to the ground with the solely the distal ends of the bristles projecting out of said recessed pocket such that upon use and forward movement of the grapple arrangement said bristles brush against tree waste debris under said bottom jaw and propel tree waste debris out from under said bottom jaw to facilitate collection thereof with minimal loading and deflection of said bristles.

9. The grapple arrangement of claim 8, wherein said rear portion and said front portion are angled or sloped upwardly away from said bottom portion of said bottom jaw to maximize sliding of said bottom jaw over a ground surface with minimal impact or engagement with the ground surface and thus minimal damage to the ground surface upon use of the grapple arrangement.

10. The grapple arrangement of claim 9, wherein the grapple arrangement further comprises a tow hitch mounted on said top jaw front edge portion to permit a user to tow a towable vehicle or trailer with the grapple arrangement.

11. The grapple arrangement of claim 1, wherein:
said bottom jaw comprises a bottom portion, a left side portion, a right side portion, a rear portion, and a front portion, all connected together to form a pan or trough; and
said front portion and said bottom portion taper in width from said bottom jaw front edge portion to said rear portion to maximize the entry space for tree waste debris to facilitate collection of tree waste debris and minimize the overall size and weight of said bottom jaw to maximize maneuverability and lifting capacity of a wheeled or tracked base machine.

12. The grapple arrangement of claim 1, wherein:
said bottom jaw front edge portion comprises a bottom jaw lip being elongated and having a rounded or circular cross-section;
said top jaw front edge portion comprises a top jaw lip being elongated and having a rounded or circular cross-section; and
said top jaw lip is configured to sealingly engage with said bottom jaw lip to minimize or prevent small tree waste debris from escaping from said bottom jaw between said top teeth and said bottom teeth upon said top jaw and said bottom jaw being in said closed position.

13. The grapple arrangement of claim 2, wherein said top teeth and said bottom teeth are spaced apart and configured to interlace with one another upon said top jaw and said bottom jaw being in said closed position to capture and hold small tree waste debris not collected into said bottom jaw between adjacent teeth.

14. The grapple arrangement of claim 1, wherein:
said top jaw comprises a left arm arrangement, a right arm arrangement, and a front plate being elongated and extending transverse to and mounted at the distal ends of said left arm arrangement and said right arm arrangement;
said top jaw front edge portion is disposed on said front plate;
said left arm arrangement and said right arm arrangement are spaced apart from one another and connected to opposite ends of said front plate;
said drive arrangement comprises a left drive device configured to raise and lower said left arm arrangement and a right drive device configured to raise and lower said right arm arrangement; and
said left arm arrangement and said right arm arrangement have an open design to permit torsional twisting or progressively limited rotation of said front plate to permit said top jaw and said bottom jaw to simultaneously grip a larger piece of tree waste debris adjacent said left arm arrangement and a smaller piece of tree waste debris adjacent said right arm arrangement or vice versa.

15. The grapple arrangement of claim 14, wherein each of said left arm arrangement and said right arm arrangement comprises a cross plate and two curved or s-shaped plates disposed essentially parallel to one another and connected together by said cross plate to form a substantially H-shaped cross-sectional profile.

16. The grapple arrangement of claim 1, wherein:
the grapple arrangement further comprises a brush head;
said brush head is mounted in a recessed pocket on the underside of said bottom jaw adjacent and rearward of said bottom jaw front edge portion; and
said brush head comprises bristles oriented transverse to the ground with the solely the distal ends of the bristles projecting out of said recessed pocket such that upon use and forward movement of the grapple arrangement said bristles brush against tree waste debris under said bottom jaw and propel tree waste debris out from under said bottom jaw to facilitate collection thereof with minimal loading and deflection of said bristles.

17. The grapple arrangement of claim 1, wherein:
said bottom jaw comprises a bottom portion, a left side portion, a right side portion, a rear portion, and a front portion, all connected together to form a pan or trough; and
said rear portion and said front portion are angled or sloped upwardly away from said bottom portion of said bottom jaw to maximize sliding of said bottom jaw over a ground surface with minimal impact or engagement with the ground surface and thus minimal damage to the ground surface upon use of the grapple arrangement.

18. The grapple arrangement of claim 1, wherein the grapple arrangement further comprises a tow hitch mounted on said top jaw front edge portion to permit a user to tow a towable vehicle or trailer with the grapple arrangement.
